(19) United States
(12) Patent Application Publication
(10) Pub. No.: US 2021/0170856 A1
(43) Pub. Date: Jun. 10, 2021

(54) DRIVE DEVICE FOR A VEHICLE AXLE OF A TWO-TRACK VEHICLE

(71) Applicant: AUDI AG, Ingolstadt (DE)

(72) Inventors: Udo PINSCHMIDT, Gaimersheim (DE); Steffen HUMMEL, Bergen (DE); Christian WIRTH, Moosinning / Eichenried (DE)

(73) Assignee: AUDI AG, Ingolstadt (DE)

(21) Appl. No.: 16/761,353

(22) PCT Filed: Oct. 18, 2018
(86) PCT No.: PCT/EP2018/078616

§ 371 Date: May 4, 2020

(30) Foreign Application Priority Data
Nov. 13, 2017 (DE) 10 2017 220 170.3

(51) Int. Cl. B60K 6/365; B60K 6/485

(52) U.S. Cl. CPC B60K 6/365; B60K 1/00; B60K 6/485

(57) ABSTRACT

A drive device for a vehicle axle, in particular a rear axle, of a two-track vehicle, wherein the rear axle has an axle differential, which can be connected to a primary drive unit on its input side, and can be connected to the vehicle wheels of the vehicle axle on its output side by means of flanged shafts arranged on both sides, wherein the vehicle axle is associated with an additional drive unit and a switchable superposition gearbox which can be switched into a torque-distribution gear stage, in which a drive torque generated by the additional drive unit is generated, wherein a torque distribution to the two vehicle wheels can be changed depending on the torque and its rotational direction, and said superposition gearbox can be switched into a hybrid mode in which the drive torque generated by the additional drive unit.

The invention relates to a drive device for a vehicle axle, in particular a rear axle, of a two-track vehicle, according to the generic term of claim 1.

DE 10 2014 015 793 A1 discloses a generic drive device for a vehicle rear axle having an axle differential, which can be connected to a primary drive unit (for example, a combustion engine) on its input side, and can on its output side be connected to the vehicle wheels of the vehicle axle by means of flanged shafts arranged on both sides. The vehicle axle is associated with an additional drive unit (in particular, an electric motor), as well as a switchable superposition gearbox. The superposition gearbox can be switched to a torque-distribution gear stage, in which a drive torque generated by the additional drive unit is generated, wherein a torque distribution to the two vehicle wheels can be changed depending on the torque and its rotational direction. Alternatively, the superposition gearbox can be switched to a hybrid mode, in which the drive torque generated by the additional drive unit can be coupled to both flanged shafts of the vehicle wheels in an evenly distributed manner in a switchable hybrid gear stage via the axle differential. In certain driving situations, e.g., during cornering, the vehicle handling can be supported via a torque redistribution (torque vectoring or differential-lock function) by engaging the torque distribution gear stage. Thus, a drive torque can be shifted toward the outside vehicle wheel (torque vectoring) when entering a curve during cornering. Alternatively/additionally, the drive torque can be shifted toward the inside vehicle wheel (differential-lock function) when exiting the curve during cornering. By contrast, a boost function can be performed when hybrid mode is activated, for example.

In the aforementioned DE 10 2014 015 793 A1, the superposition gearbox has a total of three planetary gear units that can be switched via two brakes to provide the hybrid mode or the torque-distribution mode, resulting in an overall arrangement requiring a large installation space.

The problem underlying the invention is to provide a drive device for a vehicle axle of a two-track vehicle, which is designed in an installation space-saving manner in comparison to the prior art, and in which it is possible to expand/reduce functionality with simple means, specifically while requiring less space and providing increased driving dynamics.

The problem is solved by the characteristics of claim 1. Preferred further developments of the invention are disclosed in the dependent claims.

According to the characterizing portion of claim 1, the three planetary gear units in the superposition gearbox are coupled with each other in such a way that a load path in which all three planetary gear units are engaged is formed in the superposition gearbox when the first hybrid gear stage is activated. By contrast, when the second hybrid gear stage is activated, as well as when the torque-distribution gear stage is activated, a load path is formed in the superposition gearbox, in which exactly two planetary gear units are engaged. In this way, different gear ratios can be easily realized in the first hybrid gear stage and in the second hybrid gear stage, as well as in the torque-distribution gear stage. When the second hybrid gear stage is activated, the load path is formed without a power split.

Different gear ratios can be easily realized in the first hybrid gear stage and in the second hybrid gear stage with the invention.

In a technical implementation, the three planetary gear units can be arranged consecutively in a row and coaxially to the flanged shaft. The first planetary gear unit, located on the input side of the gearbox, can be connected in a rotationally fixed manner via its input element—i.e., sun gear—to a gearbox input shaft driven by the additional drive unit. A second planetary gear unit, located on the output side of the gearbox, can have a hybrid output flange at its output element—i.e. a planetary gear carrier supporting planetary gears—which output flange is seated on a gearbox output shaft in a rotationally fixed manner, which gearbox output shaft is operationally connected to an input side of the axle differential.

With regard to a torque conversion, it is preferred if the additional drive unit is coupled with the gearbox input shaft via a countershaft stage. The additional drive unit may preferably be arranged parallel to the flanged shaft for installation space reasons, wherein the countershaft stage can be a single-stage spur gear stage, for example.

The first planetary gear unit located on the input side can be lockable or detachable from a gearbox housing via its planetary gear carrier, which supports planetary gears, by means of a hybrid switching element SH2. The first planetary gear unit can have a radially outer ring gear which meshes with the planetary gears of the first planetary gear unit. In the same manner, the second planetary gear unit can have a radially outer ring gear which meshes with the planetary gears of the second planetary gear unit. The two ring gears of the first and second planetary gear units preferably can be arranged on a common ring gear shaft in a rotationally fixed manner. In addition, the sun gear of the second planetary gear unit can be attached to the gearbox housing in such a manner that it is fixed relative to the housing.

In the above gearbox structure, the following constellation results when the second hybrid stage H2 is activated: The planetary gear carrier of the first planetary gear unit can be locked to the gearbox housing by means of the hybrid switching element SH2. In this case, a load path or a drive torque flow is formed from the additional drive unit via the first planetary gear unit and the second planetary gear unit to the input side of the axle differential.

In one concrete embodiment, the above axle differential may have a Ravigneaux gear set, in which planetary gears of a first planetary gear set mesh both with a radial outer ring gear, which forms the input side of the axle differential, and with planetary gears of a second planetary gear set. In addition, the planetary gears of the first planetary set mesh with a first, large sun gear. The planetary gears of the second planetary gear set, on the other hand, do not engage with the gears of the outer ring gear and mesh with a second, small sun gear, which is positioned axially adjacent to the first, large sun gear. The two planetary gear sets are supported rotatably on a shared planetary gear carrier in such a Ravigneaux set in a manner known from the state of the art. Such an axle differential can be connected to the superposition gearbox as follows: The first, large sun gear can be arranged on a torque-distribution output shaft in a rotationally fixed manner, while the second, small sun gear is seated on one flanged shaft (on the side of the gearbox) in a rotationally fixed manner, and the shared planetary gear carrier is seated on the other flanged shaft (away from the gearbox) in a rotationally fixed manner.

The aforementioned torque-distribution output shaft can support a torque-distribution flange in a rotationally fixed manner. This flange can be operationally coupled with or decoupled from the planetary gear carrier of the first planetary gear unit via a first torque-distribution switching element STV.

When the torque-distribution gear stage TV is activated, the following results: The torque-distribution flange can be coupled with the planetary gear carrier of the first planetary gear unit when the torque-distribution switching element STV is actuated. This results in a load path from the additional drive unit into the first planetary gear unit. A power split is conducted on the planetary gear carrier of the first planetary gear unit PG1, in which a first partial path leads via the shared ring gear shaft to the second planetary gear unit PG2 and from its hybrid output flange to the axle differential input side. A second partial path is directed via the closed torque-distribution switching element STV, as well as via the torque-distribution output shaft to the first, large sun gear of the axle differential.

In the aforementioned torque-distribution gear stage TV, the drive torque generated by the additional drive unit is not only directed to the axle differential input side, but also to the first, large sun gear of the axle differential. The torque distribution between the vehicle wheels is changed depending on the amount and the rotational direction of the drive torque introduced into the first, large sun gear.

In a further, installation space-saving version, the planetary gear carrier of the first planetary gear unit can be supported in a rotationally fixed manner on an intermediate shaft. This can preferably be realized as an outer hollow shaft. In this case, the intermediate shaft, the gearbox input shaft (as an inner hollow shaft), and the flanged shaft on the gearbox side can be arranged coaxially and nested into each other.

In the same manner, the gearbox output shaft may also be formed as an outer hollow shaft, inside which the torque-distribution output shaft (as an inner hollow shaft) is arranged, within which the flanged shaft on the gearbox side is routed.

As mentioned above, the third planetary gear unit is only engaged into the load path when the first hybrid stage is activated. Otherwise, the third planetary gear unit remains load-free when the second hybrid stage is activated or when the torque-distribution gear stage is activated. The third planetary gear unit has a sun gear that is seated in a rotationally fixed manner on the intermediate shaft, specifically together with the already mentioned planetary gear carrier of the first planetary gear unit. The sun gear of the third planetary gear unit can mesh with planetary gears supported by a planetary gear carrier. The planetary gears can also engage with the gears of a radial outer ring gear. Preferably, the planetary gear carrier of the third planetary gear unit can be connected in a rotationally fixed manner to the shared ring gear shaft. By contrast, the ring gear of the third planetary gear unit can be locked or detached from the gearbox housing by means of a hybrid switching element SH1.

In the gearbox structure defined above, the following constellation results when the first hybrid stage is activated: In the first hybrid stage H1, the ring gear of the third planetary gear unit is locked to the gearbox housing by means of the hybrid switching element SH1. In this case, a load path is formed from the additional drive unit to the first planetary gear unit and from there to the sun gear of the third planetary gear unit via the planetary gear carrier of the first planetary gear unit as well as via the intermediate shaft. The load path continues from the planetary gear carrier of the third planetary gear unit to the common ring gear shaft, as well as via the planetary gear carrier of the second planetary gear unit and the hybrid output flange to the input side of the axle differential. A power split occurs at the ring gear of the first planetary gear unit, in which a main power path leads toward the second planetary gear unit and a loss path with low reactive power branches off to the planetary gears of the first planetary gear unit. The resulting power loss is due to the inertia of the planetary gears of the first planetary gear unit, which somewhat decelerates the ring gear shaft. The discharged reactive power is fed back to the main power path on the planetary gear carrier of the first planetary gear unit.

The torque-distribution switching element STV can be realized as a shift clutch, by means of which the planetary gear carrier of the first planetary gear unit can be coupled with the torque-distribution output flange.

Alternatively, the torque-distribution switching element STV can be realized as a shift sleeve, which is arranged in a rotationally fixed manner with its internal gears and axially displaceable between a neutral position and a switching position on an external gear of the torque-distribution output flange. In the neutral position, the torque-distribution output flange is decoupled from the planetary gear carrier of the first planetary gear unit. In the switching position, the gears of the shift sleeve additionally engage with an external gear of the planetary gear carrier in order to transfer torque.

The first hybrid switching element HSE1 and the second hybrid switching element HSE2 can be two independent switching elements or alternatively can be combined into a shared hybrid switching element HSE. In this case, the shared hybrid switching element HSE can be realized as a shift sleeve axially adjustable on both sides, and can be adjustable from its neutral position either into the first hybrid gear stage H1 or into the second hybrid gear stage H2.

In the following, two exemplary embodiments of the invention are described on the basis of the attached drawings.

The drawings show:

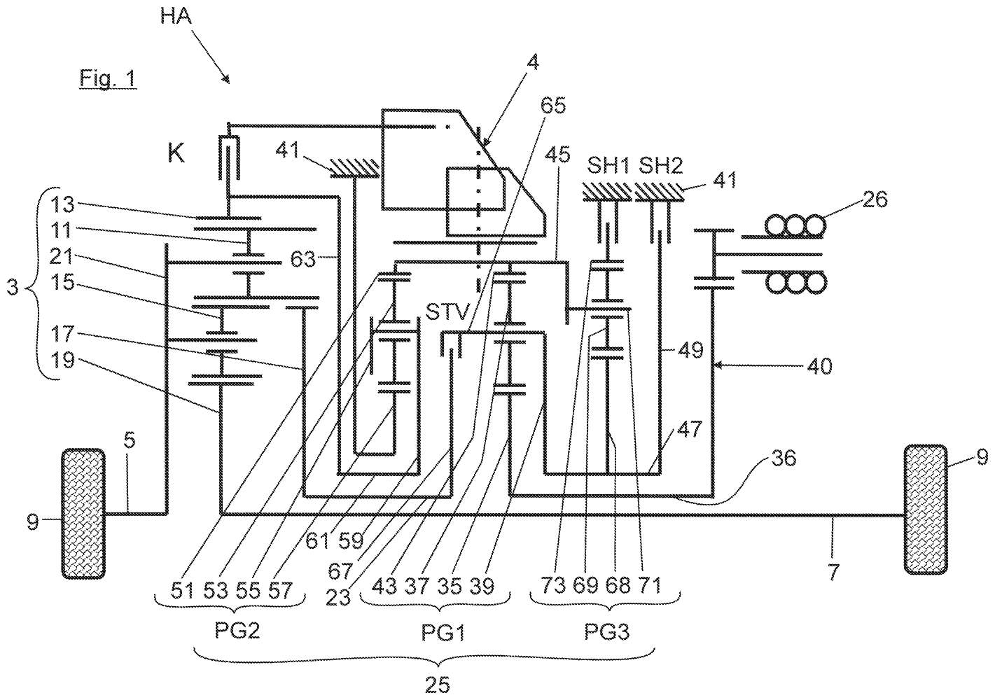

FIG. 1 A drive device for a vehicle rear axle of a two-track vehicle in a schematic representation

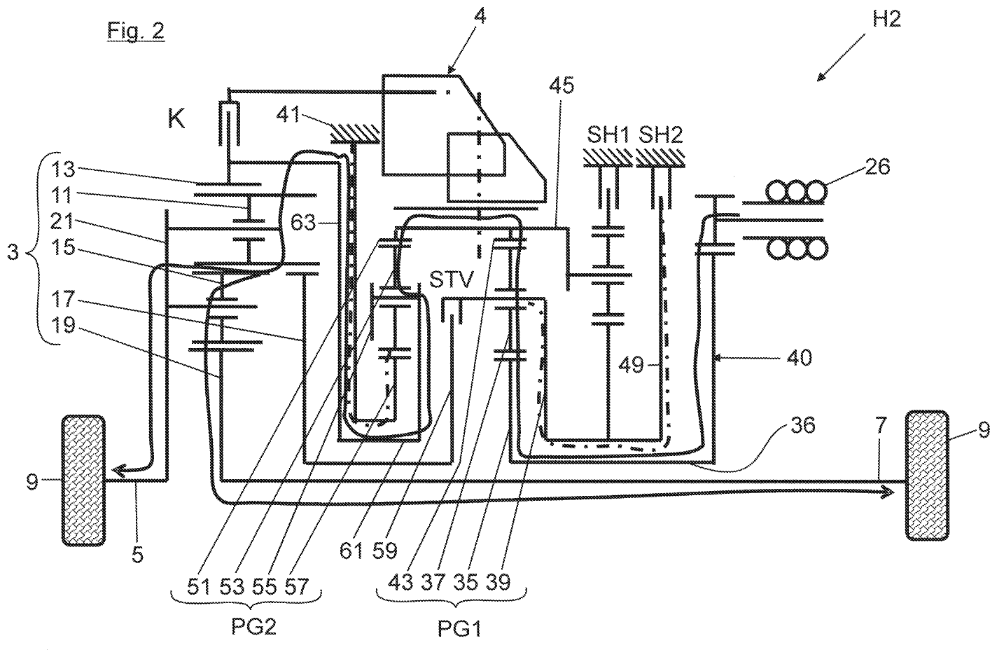

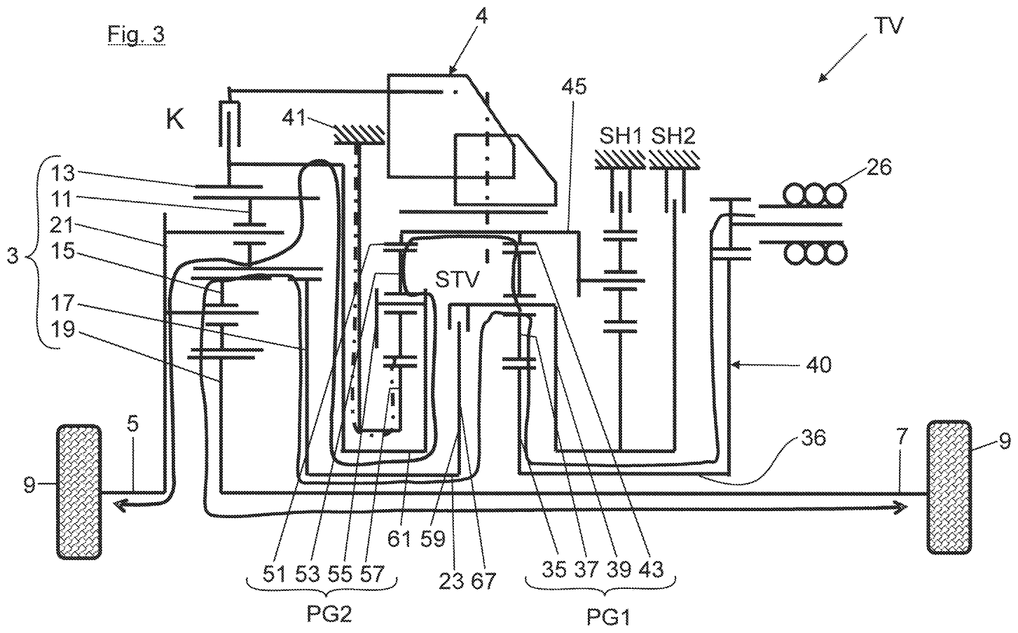

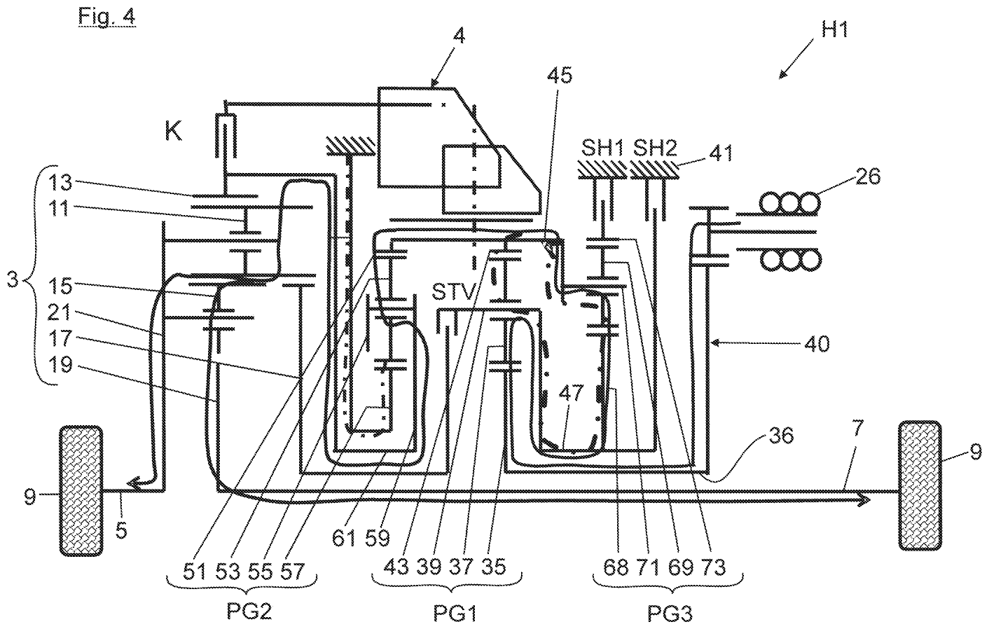

FIGS. 2 to 4 Respectively, views according to FIG. 1, with highlighted drive torque flow when the second hybrid gear stage is activated (FIG. 2), when the torque-distribution gear stage is activated (FIG. 3), and when the first hybrid gear stage (FIG. 4) is activated

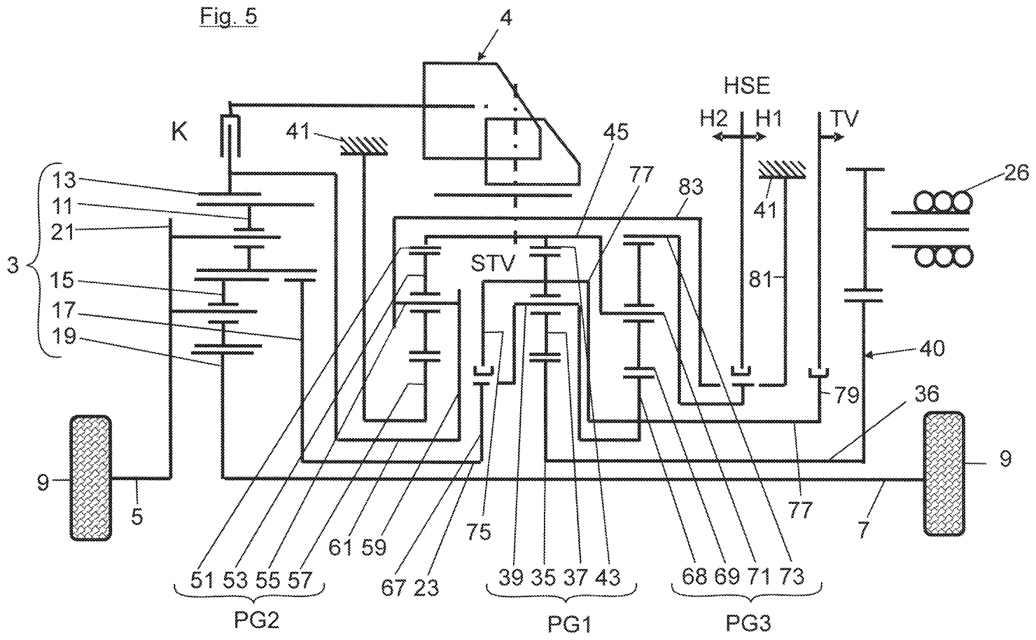

FIG. 5 A drive arrangement according to a second exemplary embodiment

FIG. 1 shows a drive device for a vehicle rear axle HA of a two-track vehicle in an approximate, schematic representation. The drive device indicated in FIG. 1 may be part of an all-wheel drive in which a front-mounted combustion engine (not shown) drives the front wheels of the vehicle as a primary drive unit via a gearbox as well as a center differential and a front axle differential. The center differential can be operationally connected to the input side 13 of a rear axle differential 3 via a drive shaft as well as via a bevel-gear drive 4. A clutch K is connected between the bevel-gear drive 4 and the input side 13 of the rear axle differential 3, by means of which clutch K the rear axle HA can be operationally decoupled from the drive shaft.

On its output side, the rear axle differential 3 is operationally coupled with the vehicle rear wheels 9 of the vehicle rear axle HA via flanged shafts 5, 7 arranged on both sides. In FIG. 1, the rear axle differential 3 is a planetary gear differential with a Ravigneaux gear set, in which planetary gears 11 of a first planetary gear set mesh both with a radial outer ring gear 13, which forms the input side of the axle differential 3, and with planetary gears 15 of a second planetary gear set. In addition, the planetary gears 11 of the first planetary gear set engage with a first, large sun gear 17. The planetary gears 15 of the second planetary gear set, on the other hand, engage with a second, small sun gear 19. Both planetary gear sets are rotatably supported on a shared planetary gear carrier 21, which is seated in a rotationally fixed manner on a flanged shaft 5 located away from the gearbox. By contrast, the second, small sun gear 19 is seated in a rotationally fixed manner on the flanged shaft 7 on the gearbox side, while the first, large sun gear 17 is seated in a rotationally fixed manner on a torque-distribution output shaft 23, which is connected to the superposition gearbox 25.

The rear axle HA has an already mentioned superposition gearbox 25 and an electric motor 26. The superposition gearbox 25 can be operated in a hybrid mode or in a torque-distribution mode (i.e., electronic torque vectoring or differential-lock function), as described below. In hybrid mode, a drive torque generated by the electric motor 26 is coupled in an evenly distributed manner to the two flanged shafts 5, 7 via the superposition gearbox 25 and via the rear axle differential 3. The hybrid mode can be implemented purely by means of the electric motor 26 or in a combination of the electric motor 26 with the combustion engine (for example, for a boost function).

In the torque-distribution mode, the drive torque generated by the electric motor 26 is not only directed to the input side (i.e., the ring gear 13) of the axle differential 3, but also, via the superposition gearbox 25, to the first, large sun gear 17 of the axle differential 3, in order to change a torque distribution to the two rear wheels 9. The application of the torque to the first, large sun gear 17 takes place via a torque-distribution flange 67 seated on the torque-distribution-output shaft 23. The torque distribution between the vehicle wheels 9 is performed depending on the amount and the rotational direction of the drive torque generated by the electric motor 26.

The gearbox structure of the superposition gearbox 25 is explained below on the basis of FIG. 1: Accordingly, the superposition gearbox 25 has a first planetary gear unit PG1 on its input-side, a second planetary gear unit PG2 and a third planetary gear unit PG3, which, seen in the transverse direction y of the vehicle, are arranged directly adjacent to each other and coaxially aligned on the flanged shaft 7 on the gearbox side. The middle, first planetary gear unit PG1 is connected in a rotationally fixed manner via its sun gear 35 (which acts as an input element) with a gearbox input shaft 36 driven by the electric motor 26. The first planetary gear unit PG1 located on the input side can be locked or detached from a gearbox housing 41 via its planetary gear carrier 39, which supports planetary gears 37, by means of a hybrid switching element SH2. In addition, the first planetary gear unit PG1 has a radial outer ring gear 43, which meshes with the planetary gears 37 and which is a one-piece component of a ring gear shaft 45. The planetary gear carrier 39 of the first planetary gear unit PG1 is connected in a rotationally fixed manner with an intermediate shaft 47, specifically together with a locking flange 49, which interacts with the hybrid switching element HS2.

The second planetary gear unit PG2 located on the gearbox output side has a radial outer ring gear 51, which is seated in a rotationally fixed manner together with the ring gear 43 of the first planetary gear unit PG1 on the shared ring gear shaft 45. The ring gear 51 meshes with radial inner planetary gears 53, which are supported rotatably on a planetary gear carrier 55 and engage with a sun gear 57. In FIG. 1, the sun gear 57 of the second planetary gear unit PG2 is attached non-rotatably to a housing wall of the gearbox housing 41. The planetary gear carrier 55 has a hybrid output flange 59, which is seated in a rotationally fixed manner on a gearbox output shaft 61, which is connected in a rotationally fixed manner with the input-side ring gear 13 of the axle differential 3 via a connection flange 63.

On the side facing the second planetary gear unit PG2, the planetary gear carrier 39 of the first planetary gear unit PG1 is extended with an axial bar 65, which supports a torque-distribution switching element STV. This interacts with a torque-distribution output flange 67, which is seated in a rotationally fixed manner on the already mentioned torque-distribution output shaft 23, which is connected to the first, large sun gear 17 of the axle differential 3.

In FIG. 1, the third planetary gear unit PG3 has a sun gear 68 which is arranged on the intermediate shaft 47 in a rotationally fixed manner together with the planetary gear carrier 39 of the first planetary gear unit PG1 and the locking flange 49. The sun gear 68 meshes with planetary gears 69, which are supported by a planetary gear carrier 71 and also engage with a radial outer ring gear 73. The planetary gear carrier 71 is attached in a rotationally fixed manner to the shared ring gear shaft 45, while the ring gear 73 can be locked to or detached from the gearbox housing 41 by means of a hybrid switching element SH1.

The gearbox input shaft 36 is connected to the electric motor 26, which is positioned parallel to the flanged shafts 5, 7, via a single-stage spur gear stage 40, which acts as a countershaft. In addition, the intermediate shaft 47 is realized as an outer hollow shaft, within which the gearbox input shaft 36 (as an inner hollow shaft) is arranged coaxially. The gearbox-side flanged shaft 7 extends within the gearbox input shaft 36. In the same way, the gearbox output shaft 61 also is formed as an outer hollow shaft, inside which extends the torque-distribution output shaft 23 (as an inner hollow shaft). The gearbox-side flanged shaft 7 extends within the latter.

In order to explain the operating principle of the drive device, a driving situation is described on the basis of FIG. 2, in which the second hybrid gear stage H2 is activated. In the present case, the second hybrid gear stage H2 is designed as a CO₂-optimized driving gear as an example, which gear can be actuated at higher driving speeds. When the second hybrid gear stage H2 is activated, the locking flange 49 is attached in a fixed manner to the gearbox housing 41 by means of the switching element SH2. This results in a load path without power splits, in which the drive torque generated by the electric motor 26 is first directed to the sun gear 35 of the first planetary gear unit PG1 via the countershaft 40 and the gearbox input shaft 36. The planetary gear carrier 39 of the first planetary gear unit PG1, which is locked in position by means of the hybrid switching element SH2, acts as a reactive element, via which the drive torque is directed to the shared ring gear shaft 45. From there, the load path is routed via the planetary gear carrier 55 of the second planetary gear unit PG2 and its hybrid output flange 59 to the input-side ring gear 13 of the axle differential 3. From there, the drive torque is evenly distributed between the two flanged shafts 5, 7 via the Ravigneaux set. In FIG. 2 (as well as in FIGS. 3, 4 and 5), the load paths are marked with a solid line, while power-dissipation load paths, through which reactive power passes, are indicated by a dotted line.

FIG. 3 shows another driving situation, in which, in contrast to FIG. 2, the superposition gearbox 25 is not operated in hybrid mode, but in torque-distribution mode. This mode is activated during cornering, for example, to achieve a torque difference between the flanged shafts 5, 7. In the torque-distribution mode, the two hybrid switching elements HS1, HS2 are released, while the torque-distribution switching element STV is activated. This results in a load path, in which the drive torque generated by the electric motor 26 is first directed to the first planetary gear unit PG1. A power split is conducted on its planetary gear carrier 39, in which a first partial path leads via the shared ring gear shaft 45 to the second planetary gear unit PG2 and from the latter's hybrid output flange 59 on to the axle differential input side (ring gear 13). A second partial path results via the closed torque-distribution switching element STV, the torque-distribution output flange 67, as well as via the torque-distribution output shaft 23 to the first, large sun gear 17 of the axle differential 3. Therein, the rotational direction and the amount of the drive torque generated by the electric motor 26 is designed in such a way that a torque is applied to or received from the first planetary gear set of the axle differential, whereby a torque distribution changes between the two flanged shafts 5, 7.

In FIG. 4, another driving situation is indicated, in which the first hybrid gear stage H1 is activated, which can be set up as a starting gear, for example. Thus, in FIG. 4, the ring gear 73 of the third planetary gear unit PG is locked to the gearbox housing 41 by means of the hybrid switching element SH1. This results in a load path from the electric motor 26 to the first planetary gear unit PG1 and from there via its planetary gear carrier 39 as well as the intermediate shaft 47 to the sun gear 68 of the third planetary gear unit PG3. The load path continues via the planetary gear carrier 71 of the latter to the shared ring gear shaft 45 to the output-side second planetary gear unit PG2. From there, the drive torque is routed via the hybrid output flange 59 to the input side (ring gear 13) of the axle differential 3.

As shown by a dotted line in FIG. 4, a power split occurs at the ring gear 43 of the first planetary gear unit PG1, in which a slight power dissipation is diverted from the main load path defined above toward the planetary gears 37 of the first planetary gear unit 1. The dissipated power is fed back to the main power path at the planetary gear carrier 39 of the first planetary gear unit PG1.

In FIGS. 1 to 4, the torque-distribution switching element STV is realized as a shift clutch, by means of which the planetary gear carrier 39 of the first planetary gear unit PG1 can be coupled with the torque-distribution output flange 67. In contrast, the torque-distribution switching element STV is realized as a shift sleeve in FIG. 5. The latter is arranged in a rotationally fixed manner and axially displaceable between a neutral position and a switching position on an external gear of the torque-distribution output flange 67. In the neutral position shown here, the torque-distribution output flange 67 is decoupled from the planetary gear carrier 39 of the first planetary gear unit PG1. In the shift position, the shift sleeve allows a torque transmission between the planetary gear carrier 39 of the first planetary gear unit PG1 and the torque-distribution output flange 67.

In FIG. 5, the shift sleeve is axially adjustable by means of a shifts fork 75. The shift fork 75 is supported by a shift rail 77 for transmitting a shifting motion, which rail extends in the axial direction through the transmission gearbox 25. The shifting motion is initiated at the end 79 of the shift rail 77 that is away from the shift fork.

In contrast to FIGS. 1 to 4, the first hybrid switching element HSE1 and the second hybrid switching element HSE2 are combined into a shared hybrid switching element HSE in FIG. 5. The shared hybrid switching element HSE is realized as a shift sleeve axially adjustable on both sides, which is adjustable from its neutral position either into the first hybrid gear stage H1 or into the second hybrid gear stage H2.

When the first hybrid gear stage H1 is activated, the shared hybrid switching element HSE couples the ring gear 73 of the third planetary gear unit PG3 with a housing wall 81 of the gearbox housing 41. When the second hybrid gear stage H2 is activated, the shared hybrid switching element HSE couples the ring gear 73 of the third planetary gear unit PG3 with an outer shaft 83, which is connected in a rotationally fixed manner to the planetary gear carrier 55 of the second planetary gearbox PG2.

In FIG. 5, in contrast to FIGS. 1 to 4, the intermediate shaft 47 supports only the sun gear 68 of the third planetary gear unit PG3 and the planetary gear carrier 39 of the first planetary gear unit PG1, but not the locking flange 49 shown in FIGS. 1 to 4.

1-11. (canceled)

12. A drive device for a vehicle axle, in particular a rear axle, of a two-track vehicle, wherein the rear axle has an axle differential, which can be connected to a primary drive unit on its input side, and can be connected to the vehicle wheels of the vehicle axle on its output side by means of flanged shafts arranged on both sides, wherein the vehicle axle is associated with an additional drive unit and a switchable superposition gearbox which can be switched into a torque-distribution gear stage, in which a drive torque generated by the additional drive unit is generated, wherein a torque distribution to the two vehicle wheels can be changed depending on the torque and its rotational direction, and said superposition gearbox can be switched into a hybrid mode in which the drive torque generated by the additional drive unit can be coupled to both flanged shafts of the vehicle wheels in an evenly distributed manner via the axle differential, wherein the superposition gearbox has three inter-coupled planetary gear units, and in that, when a first hybrid gear stage, in particular a starting gear, is activated, a load path is formed in the superposition gearbox in which all three planetary gear units are engaged, and in that, when either the torque-distribution gear or a second hybrid gear stage is activated, a load path is formed in the superposition gearbox in which exactly two planetary gear units are engaged.

13. The drive device according to claim 12, wherein the three planetary gear units are arranged consecutively in a row and coaxially to the flanged shaft, and in that a first planetary gear unit, located on the input side of the gearbox, is connected in a rotationally fixed manner via its input element, a sun gear to a gearbox input shaft driven by the additional drive unit, and in that a second planetary gear unit, located on the output side of the gearbox, is arranged on a gearbox output shaft in a rotationally fixed manner via its output element, a planetary gear carrier supporting planetary gears wherein said gearbox output shaft is operationally connected to an input side of the axle differential.

14. The drive device according to claim 13, wherein the first planetary gear unit located on the input side can be lockable or detachable from a gearbox housing via its planetary gear carrier, which supports planetary gears, by a switching element, and in that a ring gear of the first planetary gear unit and a ring gear of the second planetary gear unit are arranged in a rotationally fixed manner on a shared ring gear shaft, and in that the sun gear of the second planetary gear unit is fixed to the housing.

15. The drive device according to claim 14, wherein, in the second hybrid stage, the planetary gear carrier of the second planetary gear unit is locked to the gearbox housing by the switching element, such that a load path results from the additional drive unit via the first planetary gear unit and the second planetary gear unit to the input side of the axle differential.

16. The drive device claim 12, wherein the axle differential has a Ravigneaux gear set, in which planetary gears of a first planetary gear set mesh both with a radial outer ring gear, which forms the input side of the axle differential, via respective planetary gears of a second planetary gear set and with a first, large sun gear, and in that the planetary gears of the second planetary gear set mesh with a second, small sun gear, wherein the two planetary gear sets are supported rotatably on a shared planetary gear carrier, and in that in particular the first, large sun gear is arranged in a rotationally fixed manner on a torque-distribution output shaft, the second, small sun gear is arranged in a rotationally fixed manner on the one flanged shaft and the shared planetary gear carrier is arranged in a rotationally fixed manner on the other flanged shaft.

17. The drive device according to claim 16, wherein the torque-distribution output shaft supports a torque-distribution flange in a rotationally fixed manner, which torque-distribution flange can be operationally coupled to or decoupled from a torque-distribution switching element via the planetary gear carrier of the first planetary gear unit.

18. The drive device according to claim 17, wherein the torque-distribution flange is operationally coupled with the planetary gear carrier in the torque-distribution gear stage, such that a load path is formed from the additional drive unit to the first planetary gear unit, wherein a power split is conducted on its planetary gear carrier, in which a first partial path leads to the second planetary gear unit via the shared ring gear shaft and from its hybrid output flange to the axle differential input side, and in which a second partial path leads via the closed torque-distribution switching element, the torque-distribution output flange and the torque-distribution output shaft to the first, large sun gear of the axle differential.

19. The drive device according to claim 13, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

20. The drive device according to claim 17, wherein the gearbox output shaft is formed as an outer hollow shaft, and in that the gearbox output shaft, the torque-distribution output shaft formed as an inner hollow shaft, and the flanged shaft on the gearbox side are arranged coaxially and nested into each other.

21. The drive device according to claim 19, wherein the third planetary gear unit has a sun gear that is seated in a rotationally fixed manner on the intermediate shaft and meshes with planetary gears, which are supported by a planetary gear carrier, wherein the planetary gears engage with a radial outer ring gear, and in that in particular the planetary gear carrier of the third planetary gear unit is connected in a rotationally fixed manner to the shared ring gear shaft and in that the ring gear of the third planetary gear unit can be locked to or detached from the gearbox housing by means of a hybrid switching element.

22. The drive device according to claim 21, wherein, in the first hybrid stage, the ring gear of the third planetary gear unit is locked to the gearbox housing by the hybrid switching element, such that a load path results from the additional drive unit to the first planetary gear unit and from there via its planetary gear carrier as well as the intermediate shaft to the sun gear of the third planetary gear unit, from where the load path continues via the planetary gear carrier of the third planetary gear unit to the shared ring gear shaft and via the second planetary gear unit to the input side of the axle differential.

23. The drive device claim 13, wherein the axle differential has a Ravigneaux gear set, in which planetary gears of a first planetary gear set mesh both with a radial outer ring gear, which forms the input side of the axle differential, via respective planetary gears of a second planetary gear set and with a first, large sun gear, and in that the planetary gears of the second planetary gear set mesh with a second, small sun gear, wherein the two planetary gear sets are supported rotatably on a shared planetary gear carrier, and in that in particular the first, large sun gear is arranged in a rotationally fixed manner on a torque-distribution output shaft, the second, small sun gear is arranged in a rotationally fixed manner on the one flanged shaft and the shared planetary gear carrier is arranged in a rotationally fixed manner on the other flanged shaft.

24. The drive device claim 14, wherein the axle differential has a Ravigneaux gear set, in which planetary gears of a first planetary gear set mesh both with a radial outer ring gear, which forms the input side of the axle differential, via respective planetary gears of a second planetary gear set and with a first, large sun gear, and in that the planetary gears of the second planetary gear set mesh with a second, small sun gear, wherein the two planetary gear sets are supported rotatably on a shared planetary gear carrier, and in that in particular the first, large sun gear is arranged in a rotationally fixed manner on a torque-distribution output shaft, the second, small sun gear is arranged in a rotationally fixed manner on the one flanged shaft and the shared planetary gear carrier is arranged in a rotationally fixed manner on the other flanged shaft.

25. The drive device claim 15, wherein the axle differential has a Ravigneaux gear set, in which planetary gears of a first planetary gear set mesh both with a radial outer ring gear, which forms the input side of the axle differential, via respective planetary gears of a second planetary gear set and with a first, large sun gear, and in that the planetary gears of the second planetary gear set mesh with a second, small sun gear, wherein the two planetary gear sets are supported rotatably on a shared planetary gear carrier, and in that in particular the first, large sun gear is arranged in a rotationally fixed manner on a torque-distribution output shaft, the second, small sun gear is arranged in a rotationally fixed manner on the one flanged shaft and the shared planetary gear carrier is arranged in a rotationally fixed manner on the other flanged shaft.

26. The drive device according to claim 14, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

27. The drive device according to claim 15, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

28. The drive device according to claim 16, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

29. The drive device according to claim 17, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

30. The drive device according to claim 18, wherein the planetary gear carrier of the first planetary gear unit is supported in a rotationally fixed manner by an intermediate shaft formed as an outer hollow shaft, and in that the intermediate shaft, the gearbox input shaft formed as an inner hollow shaft, and the flanged shaft on the gearbox side are arranged coaxially and nested into each other.

31. The drive device according to claim 18, wherein the gearbox output shaft is formed as an outer hollow shaft, and in that the gearbox output shaft, the torque-distribution output shaft formed as an inner hollow shaft, and the flanged shaft on the gearbox side are arranged coaxially and nested into each other.
